(19) United States
(12) Patent Application Publication
(10) Pub. No.: US 2022/0067091 A1
(43) Pub. Date: Mar. 3, 2022

(54) SYSTEM AND METHOD FOR ADAPTIVE RANKING OF PLURALITY OF VIDEO SEGMENTS

(71) Applicant: Smile Internet Technologies Private Limited, Gurugram (IN)

(72) Inventors: Siddharth PURI, NOIDA (IN); Vaibhav PANDEY, Delhi (IN); Arpit GOEL, Delhi (IN); Daman ARORA, Jalandhar (IN)

(73) Assignee: Smile Internet Technologies Private Limited, Gurugram (IN)

(21) Appl. No.: 17/008,473

(22) Filed: Aug. 31, 2020

(51) Int. Cl. G06F 16/738; G06K 9/00; G10L 25/57; G06F 16/74; G06F 16/75; G06F 16/2457; G06F 16/78; G06N 20/00

(52) U.S. Cl. CPC G06F 16/738; G06K 9/00765; G06K 9/00744; G10L 25/57; G06N 20/00; G06F 16/75; G06F 16/24578; G06F 16/7867; G06F 16/743

(57) ABSTRACT

The present disclosure provides a computer-implemented method and system for adaptive ranking of a plurality of video segments. The method includes a first step of receiving a multimedia content. In addition, the method includes another step of displaying the plurality of video segments on one or more social media. Further, the method includes yet another step of ranking the plurality of video segments. Furthermore, the method includes yet another step of extracting one or more attributes associated with first group of video segments in real-time. Moreover, the method includes yet another step of clustering of the first group of video segments in real-time.

### TECHNICAL FIELD

The present invention relates to the field of advertisement technology and in particular, relates to a system and method for adaptive ranking of video segments.

### INTRODUCTION

With advancements in technology over last few years, social media platforms have been used for advertising many video contents of various media service providers. The various media service providers includes Netflix, Amazon prime, HotStar and the like.

These various media service providers hire many campaign managers to advertise various video contents on the social media platforms. The video contents are selected, edited and uploaded by the campaign managers on the social media platforms for advertisement purposes. In addition, the campaign managers have to follow various video related rules of the social media platforms. The audio and video content are created to catch as many eyeballs as possible. For example, businesses advertise their products or services on different digital advertisement mediums such as televisions, radio, Internet, and the like. Similarly, a movie production house wants to show a video trailer of a movie to as many people as it can. On the same lines, a politician wants people to listen to his speech by as many people as possible. Most of these businesses, entities and other people who create audio and/or video content want insights about how many people were actually exposed to the content.

### SUMMARY

In a first example, a computer-implemented method is provided. The computer-implemented method for adaptive ranking of a plurality of video segments in real-time. The method includes a first step of receiving a multimedia content at an adaptive ranking system with a processor. In addition, the method includes another step of displaying the plurality of video segments on one or more social media platforms at the adaptive ranking system with the processor. Further, the method includes yet another step of ranking the plurality of video segments displayed on the one or more social media platforms at the adaptive ranking system with the processor. Furthermore, the method includes yet another step of extracting one or more attributes associated with a first group of video segments in real-time at the adaptive ranking system with the processor. Moreover, the method includes yet another step of clustering the first group of video segments in real-time at the adaptive ranking system with the processor. The multimedia content is received from one or more input devices in real-time. The multimedia content is divided to create the plurality of video segments in real-time. The plurality of video segments is created based on one or more parameters. The plurality of video segments is displayed on the one or more social media platforms in real time. The ranking of the plurality of video segments is based on a performance data of each of the plurality of video segments over the one or more social media platforms. In addition, the plurality of video segments is ranked for targeting the plurality of users based on one or more factors. Further, video segments of the plurality of video segments that exceeds a predefined threshold are a first group of video segments. Furthermore, the one or more attributes are extracted by performing audio excitement analysis of the first group of video segments. Moreover, the clustering of the first group of video segments is done based on the one or more attributes and audio excitement analysis to optimize the adaptive ranking system. The first group of video segments are clustered using machine learning algorithms.

In an embodiment of the present disclosure, the multimedia content includes at least one of text, audio, video, animation and graphics interchange format (GIF).

In an embodiment of the present disclosure, the one or more parameters include at least one of an audio continuity, a video continuity and an intersection of the audio continuity and the video continuity.

In an embodiment of the present disclosure, the plurality of video segments is displayed on the one or more social media platforms based on one or more requirements.

In addition, the one or more requirements include at least one of an aspect ratio of the plurality of video segments, an orientation of the plurality of video segments and duration of the plurality of video segments.

In an embodiment of the present disclosure, the one or more factors include location, community, language, ethnicity, gender and age groups.

In an embodiment of the present disclosure, the performance data includes likes, number of views, watch-hour on the plurality of video segments and number of dislikes, age group of people who like or dislike the plurality of video segments, gender of people that likes or dislikes the plurality of video segments, location at which the plurality of video segments are mostly watched.

In an embodiment of the present disclosure the one or more attributes associated with the first group video segments include audio attributes, visual attributes and an intersection of the audio attributes and the visual attributes.

In an embodiment of the present disclosure, the adaptive ranking system includes sub-clustering of the first group of video segments. In addition, the first group of video segments are sub-clustered to target audience from the plurality of users based on parameters. The parameters include location, community, language, ethnicity, gender and age group.

In an embodiment of the present disclosure, the adaptive ranking system includes targeting of the first group of video segments. In addition, the first group of video segments are targeted on the one or more social media platforms by analyzing device data of a plurality of users.

In an embodiment of the present disclosure, the adaptive ranking system includes notifying the first group of video segments. In addition, the first group of video segments are notified to each of the plurality of users on the one or more social media platforms at the adaptive ranking system.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for adaptive ranking of a plurality of video segments in real-time. The method includes a first step of receiving a multimedia content at an adaptive ranking system. In addition, the method includes another step of displaying the plurality of video segments on one or more social media platforms at the adaptive ranking system. Further, the method includes yet another step of ranking the plurality of video segments displayed on the one or more social media platforms at the adaptive ranking system. Furthermore, the method includes yet another step of extracting one or more attributes associated with a first group of video segments in real-time at the adaptive ranking system. Moreover, the method includes yet another step of clustering the first group of video segments in real-time at the adaptive ranking system. The multimedia content is received from one or more input devices in real-time. The multimedia content is divided to create the plurality of video segments in real-time. The plurality of video segments is created based on one or more parameters. The plurality of video segments is displayed on the one or more social media platforms in real time. The ranking of the plurality of video segments is based on a performance data of each of the plurality of video segments over the one or more social media platforms. In addition, the plurality of video segments is ranked for targeting the plurality of users based on one or more factors. Further, video segments of the plurality of video segments that exceeds a predefined threshold are a first group of video segments. Furthermore, the one or more attributes are extracted by performing audio excitement analysis of the first group of video segments. Moreover, the clustering of the first group of video segments is done based on the one or more attributes and audio excitement analysis to optimize the adaptive ranking system. The first group of video segments are clustered using machine learning algorithms.

In a third example, a non-transitory computer-readable storage medium is provided. The non-transitory computer-readable storage medium encodes computer executable instructions. The computer executable instructions are executed by at least one processor to perform a method for adaptive ranking of a plurality of video segments in real-time. The method includes a first step of receiving a multimedia content at a computing device. In addition, the method includes another step of displaying the plurality of video segments on one or more social media platforms at the computing device. Further, the method includes yet another step of ranking the plurality of video segments displayed on the one or more social media platforms at the computing device. Furthermore, the method includes yet another step of extracting one or more attributes associated with a first group of video segments in real-time at the computing device. Moreover, the method includes yet another step of clustering the first group of video segments in real-time at the computing device. The multimedia content is received from one or more input devices in real-time. The multimedia content is divided to create the plurality of video segments in real-time. The plurality of video segments is created based on one or more parameters. The plurality of video segments is displayed on the one or more social media platforms in real time. The ranking of the plurality of video segments is based on a performance data of each of the plurality of video segments over the one or more social media platforms. In addition, the plurality of video segments is ranked for targeting the plurality of users based on one or more factors. Further, video segments of the plurality of video segments that exceeds a predefined threshold are a first group of video segments. Furthermore, the one or more attributes are extracted by performing audio excitement analysis of the first group of video segments. Moreover, the clustering of the first group of video segments is done based on the one or more attributes and audio excitement analysis to optimize the adaptive ranking system. The first group of video segments are clustered using machine learning algorithms.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment for adaptive ranking of a plurality of video segments, in accordance with various embodiments of the present disclosure;

FIG. 2 illustrates a flow chart of a method for adaptive ranking of the plurality of video segments, in accordance with various embodiments of the present disclosure; and

FIG. 3 illustrates a block diagram of the computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

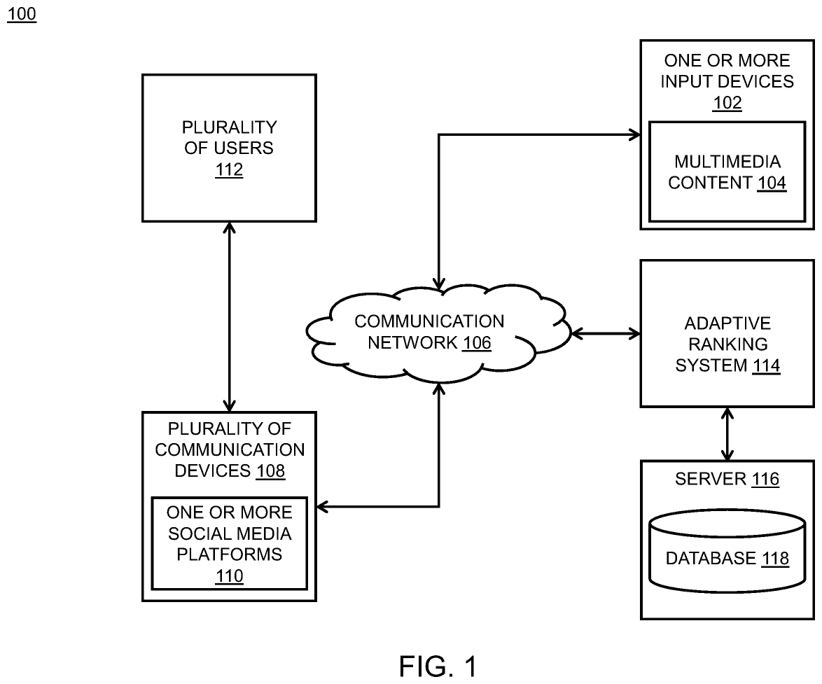

FIG. 1 illustrates a general overview of an interactive computing environment 100 for performing adaptive ranking of a plurality of video segments in real-time, in accordance with various embodiments of the present disclosure. The interactive computing environment 100 illustrates an environment suitable for an interactive reception and analysis of multimedia content 104 for creating the plurality of video segments. The interactive computing environment 100 is configured to provide a setup for creating the plurality of video segments. The interactive computing environment 100 is configured to create and analyze the plurality of video segments. The interactive computing environment 100 includes one or more input devices 102, a multimedia content 104, a communication network 106, a plurality of communication devices 108 and one or more social media platforms 110. In addition, the interactive computing environment includes an adaptive ranking system 114, a server 116 and a database 118.

Further, the plurality of communication devices 108 is associated with a plurality of users 112. The interactive computing environment 100 includes the plurality of users 112. In an example, each user of the plurality of users may be a social media user or an individual who needs access to social media content. In an embodiment of the present disclosure, each of the plurality of users 112 is associated with the plurality of communication devices 108. In an embodiment of the present disclosure, each user of the plurality of users 112 is an owner of each of the plurality of communication devices 108. Moreover, the plurality of users 112 may be any person or individual accessing the corresponding the plurality of communication devices 108. Also, the one or more social media platforms 110 is associated with the plurality of communication devices 108. The above stated elements of the interactive computing environment 100 operate coherently and synchronously to create and analyze the plurality of video segments.

The interactive computing environment 100 includes the one or more input devices 102. In general, input device refers to hardware device that transfers data to computer.

In an embodiment of the present disclosure, the one or more input devices 102 receives the multimedia content 104 from one or more video sources. In addition, the one or more video sources includes one or more databases. In an example, one or more databases includes amazon web services, content distribution network, datacenters and the like. In an example, “YouTube” stores video content in datacenters and content distribution network. In another example, “Netflix” is storing data in combination of hardware devices crammed together in a server. The one or more input devices 102 are associated with the adaptive ranking system 114. In an embodiment of the present disclosure, the one or more input devices 102 transfers the multimedia content 104 to the adaptive ranking system 114. In an embodiment of the present disclosure, the one or more input devices 102 includes but my not be limited to at least one of keyboard, mouse, scanner, digital camera, microphone, digitizer, joystick. In an example, the one or more input devices provides input to adaptive ranking system in the form of text, audio, video and the like. In general, multimedia content uses combination of different content forms such as text, audio, images, animations, video and interactive content. In an embodiment of the present disclosure, the multimedia content 104 includes but may not be limited to text, audio, and video. In an example, a user X is associated with an electronic device (say, a laptop). The user X receives a multimedia content in form of a text embedded with information. In addition, the user X transforms the text into video segments using an electronic device. Further, the video segments being broadcasted on social media channels.

In an embodiment of the present disclosure, the multimedia content 104 undergoes video segmentation process. In addition, the video segmentation process breaks the multimedia content 104 into the plurality of video segments using the adaptive ranking system 114. In general, video segmentation is process of breaking out video in constituent basic elements, shots, high-level aggregates like episodes or scenes. In an embodiment of the present disclosure, the multimedia content 104 is being divided into the plurality of video segments based on one or more parameters. In an embodiment of the present disclosure, the one or more parameters includes an audio continuity. In another embodiment of the present disclosure, the one or more parameters includes a video continuity. In yet another embodiment of the present disclosure, the one or more parameters includes an intersection of the audio continuity and the video continuity. The audio continuity refers to checking of continuity in an audio content present in the plurality of video segments. The video continuity refers to checking of continuity in a video content present in the plurality of video segments. The intersection of the audio continuity and the video continuity refers to seamless intersection of the audio content with respective video content. In an example, a user A is associated with an electronic device (say, a computer) receives a movie trailer. In addition, the electronic device splits the movie trailer in number of video segments (say, ten). Further, the electronic device splits the movie trailer using number of algorithms. Furthermore, the number of algorithms ensures complete dialogue present in the number of video segments, ensures complete scene present in the number of video segments and ensures complete scene present with dialogue in the number of video segments. In an embodiment of the present disclosure, the plurality of video segments is being selected based on the one or more parameters. In an example, video segments being selected by ensuring continuity of dialogue in the video segments. In another example, the video segments being selected by ensuring the continuity of video scene in the video segments. In yet another example, the video segments being selected by checking the continuity of dialogue with video scene in the video segments.

The interactive computing environment 100 includes the communication network 106. The communication network 106 is associated with the plurality of communication devices 108. In an embodiment of the present disclosure, the communication network 106 transfers the plurality of video segments to the plurality of communication devices 108 using the adaptive ranking system 114. In general, communication devices are hardware devices capable of transmitting data. The plurality of communication devices 108 is hardware devices capable of transmitting the plurality of video segments on the one or more social media platforms 110 using the communication network 106.

The interactive computing environment 100 includes the plurality of communication devices 108. In an embodiment of the present disclosure, the plurality of communication devices 108 includes but may not be limited to smart phone, tablet, laptop and personal digital assistant. The plurality of communication devices 108 is associated with the one or more social media platforms 110 through the communication network 106. The communication network 110 provides medium for the plurality of communication devices 108 to receive the plurality of video segments. Also, the communication network 110 provides network connectivity to the plurality of communication devices 108 using a plurality of methods. The plurality of methods is used to provide network connectivity to plurality of communication devices 108 includes 2G, 3G, 4G, Wi-Fi, BLE, LAN, VPN, WAN and the like. In an example, the communication network includes but may not be limited to a local area network, a metropolitan area network, a wide area network, a virtual private network, a global area network and a home area network.

Further, the interactive computing environment 100 includes the one or more social media platforms 110. In an example, the one or more social media platforms includes but may not be limited to WhatsApp, Facebook, Instagram, LinkedIn, Pinterest, WeChat, YouTube, Twitter, Skype, Google+, Snapchat, Hike and Telegram. In general, each social media platform provides social media content to users. In an embodiment of the present disclosure, the one or more social media platforms 110 being operated by the plurality of users 112. In addition, the plurality of video segments are displayed on the one or more social media platforms 110 based on one or more requirements. Further, the one or more requirements of the one or more social media platforms 110 includes but may not be limited to an aspect ratio, an orientation and a duration.

The interactive computing environment 100 includes the adaptive ranking system 114. The adaptive ranking system 114 is associated with the plurality of communication devices 108 through the communication network 106. In addition, the plurality of communication devices 108 is associated with the plurality of users 112 through the one or more social media platforms 110. In an embodiment of the present disclosure, the adaptive ranking system 114 performs ranking of the plurality of video segments displayed on the one or more social media platforms 110. In addition, ranking of the plurality of video segments is based on a performance data of each of the plurality of video segments over the one or more social media platforms 110. In an embodiment of the present disclosure, the performance data includes but may not be limited to likes, number of views, watch-hour on the plurality of video segments and number of dislikes, age group of people who like the plurality of video segments, gender of people that likes or dislikes the plurality of video segments, location at which the plurality of video segments are mostly watched. In addition, the plurality of video segments is ranked for targeting the plurality of users 112 based on one or more factors. In an embodiment of the present disclosure, the one or more factors includes but may not be limited to location, gender, language, community, ethnicity and age group. Further, video segments of the plurality of video segments that exceeds a predefined threshold are a first group of video segments. Furthermore, the videos having maximum views and maximum likes on the social media (say, Instagram) are first group of videos on the social media.

Further, the adaptive ranking system includes 114 includes a device data of the plurality of users 112 associated with the plurality of communication devices 108. The device data includes but may not be limited to user location, user network connectivity, user device resolution and user device information. In an embodiment of the present disclosure, the adaptive ranking system 114 fetches the device data of the plurality of user 112. In an embodiment of the present disclosure, the adaptive ranking system 114 displayed the plurality of video segments based on the device data of the plurality of users 112. In an example, a user A currently locating at rural area having low network connectivity is associated with a first communication device (say, a low-resolution mobile). In addition, a user B currently locating at urban area having high network connectivity is associated with a second communication device (say, a high-resolution mobile). Further, an intelligent device (say, a laptop), analyzes user location, first communication device and second communication device of the user A and user B. Furthermore, the intelligent device is displaying a video (say, a movie) based on network connectivity and communication device of the user A and user B.

In addition, the predefined threshold is a value specified for the plurality of video segments by the adaptive ranking system 114. In an embodiment of the present disclosure, the plurality of video segments exceeds the predefined threshold are first group of video segments. In addition, the plurality of video segments evaluating first-performance are the first group of video segments. In an example, a movie X (say, a Bollywood movie) and a movie B (say, a Hollywood movie) is being displayed on the social media. In addition, the movie B is world-wide appreciated by the users on the social media on comparing with the movie A. Further, comparison of the movie A with the movie B is being done based on value specified for watch-hour and user likes. Furthermore, the movie B exceeds the specified value and has performed-well on the social media. In another example, the value specified for watch-hour is 10 hours. In addition, the value specified for user-likes is one thousand. Further, movie exceeding the watch-hour and user likes has performed-well on social media. Furthermore, the movie

B has performed-well on social media on exceeding the value specified for watch-hour and user likes.

Furthermore, the adaptive ranking system 114 extracts one or more attributes associated with the first group of video segments in real-time. In an embodiment of the present disclosure, the one or more attributes associated with the first group of video segments being extracted by performing audio excitement analysis. In addition, the one or more attributes includes but may not be limited to audio attributes, video attributes and an intersection of the audio attributes and the video attributes. Further, the audio attributes includes but may not be limited to volume level, echo and pan. Furthermore, the visual attributes includes but may not be limited to opacity, axis, color and scale.

Moreover, the adaptive ranking system 114 performs clustering of the first group of video segments in real-time. In an embodiment of the present disclosure, the first group of video segments being clustered based on the one or more attributes and the audio excitement analysis. In addition, the clustering of the first group of video segments being performed to optimize the adaptive ranking system 114. Further, the first group of video segments being clustered based on machine learning algorithms. Furthermore, the first group of video segments being clustered to target the plurality of users 112 on the one or more social media platforms 110. In an example, a software system receives number of teasers (say, five) of a movie trailer. In addition, the number of teasers being clustered by the software system based on attributes. Further, the clustering is being performed by the software system using machine learning algorithms. In another example, the number of teasers is being clustered using k-nearest algorithm.

In an embodiment of the present disclosure, the audio excitement analysis is performed based on one or more machine learning algorithms. In addition, the one or more machine learning algorithms includes but may not be limited to linear regression, logistic regression, decision tree, sum of vector machine, naïve Bayes, k nearest neighbor, random forest, time series, k-means. In general, machine learning algorithms are used to develop different models for datasets. In addition, datasets are divided into training dataset and test dataset. Further, training dataset is used to train the model that is developed using the machine learning algorithm. Furthermore, test dataset is used to test the efficiency and accuracy of the developed model.

The adaptive ranking system 114 performs sub-clustering of the first group of video segments. In addition, the sub-clustering of the first group of video segments is performed to target audience from the plurality of users 112 based on parameters like location, gender, language, community, ethnicity and age group. In an example, a user X with age (say, 25 years) is associated with social media channel (say, Instagram). In addition, the user X likes videos having high sound. Further, a software system clusters the videos based on user interest. In another example, a user Y with age (say, 50 years) is associated with the social media channel (say, Instagram). In addition, the user Y likes video having low sound. Further, the software system clusters the videos based on user interest.

The adaptive ranking system 114 notifies the first group of video segments to the plurality of users 112 on the one or more media platforms 110. In addition, the first group of video segments are notified to target the plurality of users 112 on the one or more social media platforms 110.

The interactive computing environment 100 includes the server 116. In an embodiment of the present disclosure, the adaptive ranking system 114 is connected with the server 116. In another embodiment of the present disclosure, the server 116 is part of the adaptive ranking system 114. The server 116 handles each operation and task performed by the adaptive ranking system 114. The server 116 stores the one or more instructions and the one or more processes for performing various operations of the adaptive ranking system 114. In an embodiment of the present disclosure, the server 116 is a cloud server. The cloud server is built, hosted and delivered through a cloud computing platform. In general, cloud computing is a process of using remote network server that are hosted on the internet to store, manage, and process data. Further, the server 116 includes the database 118.

The interactive computing environment 100 includes the database 118. The database 118 is used for storage purposes. The database 118 is associated with the server 116. In general, database is a collection of information that is organized so that it can be easily accessed, managed and updated. In an embodiment of the present disclosure, the database 118 provides storage location to all data and information required by the segmentation system 114. In an embodiment of the present disclosure, the database 118 may be at least one of hierarchical database, network database, relational database, object-oriented database and the like. However, the database 118 is not limited to the above-mentioned databases.

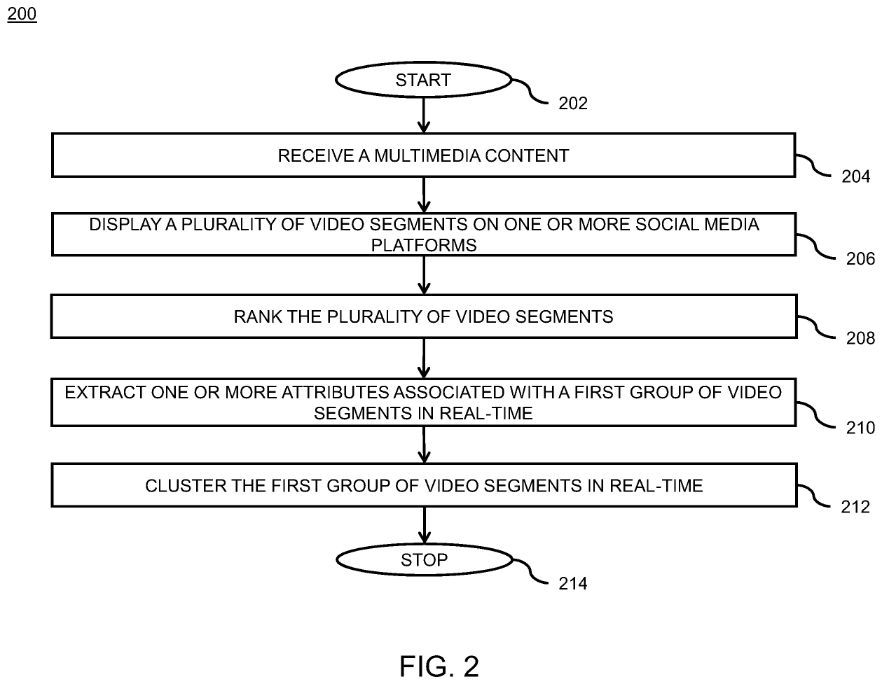

FIG. 2 illustrates a flow chart 200 for adaptive ranking of the plurality of video segments, in accordance with various embodiments of the present disclosure. The flow chart 200 initiates at step 202. Following step 202, at step 204, adaptive ranking system 114 facilitates reception of the multimedia content 104 from the one or more input devices 102 in real-time. In addition, the multimedia content 104 includes but may not be limited to text, audio and video. Further, the one or more input devices 102 includes but may not be limited to keyboard, joysticks and digital camera. Furthermore, the one or more input devices 102 extracts multimedia content 104 from the one or more video sources. Moreover, the one or more video sources includes one or more databases. Also, the one or more databases includes but may not be limited to amazon webservices, content distribution network, datacenters and one or more hardware devices crammed in server. The adaptive ranking system 114 creates the plurality of video segments from the multimedia content 104 in real-time. In addition, the creation of the plurality of video segments from the multimedia content 104 is done based on one or more parameters. Further, the one or more parameters includes the audio continuity, the video continuity and the interaction of the audio continuity and the video continuity. Furthermore, the plurality of video segments is selected based on one or more parameters.

At step 206, the plurality of video segments is displayed over the one or more social media platforms 110. In addition, the one or more social media platforms 110 includes but may not be limited to Facebook, Snapchat and Instagram. The adaptive ranking system 114 performs the ranking of the plurality of video segments based on the performance data. At step 208, ranking of the plurality of video segments is done based on the predefined threshold. In addition, video segments of the plurality of video segments that exceeds the predefined threshold are the first group of video segments.

At step 210, the one or more attributes associated with the first group of video segments are extracted using the audio excitement analysis. In addition, the audio excitement analysis of the first group of video segments is done in real-time. Further, the one or more attributes includes the visual attributes, the audio attributes and the intersection of the audio attributes and visual attributes. In an embodiment of the present disclosure, the visual attributes includes but may not be limited to opacity, axis, color and scale. In an embodiment of the present disclosure, the audio attributes includes but may not be limited to volume level, echo and pan.

At step 212, the first group of video segments are clustered in real-time. In addition, the clustering of the first group of video segments is performed based on the one or more attributes and the audio excitement analysis. Further, the clustering of the first group of video segments is being performed to optimize the adaptive ranking system 114. Furthermore, the first group of video segments are clustered to target the plurality of users 112 on the one or more social media platforms 110. Moreover, the first group of video segments being sub-clustered to target the plurality of age groups on the one or more social media platforms 110. Also, the first group of video segments are displayed on the one or more social media platforms 110. The flow chart terminates at step 214.

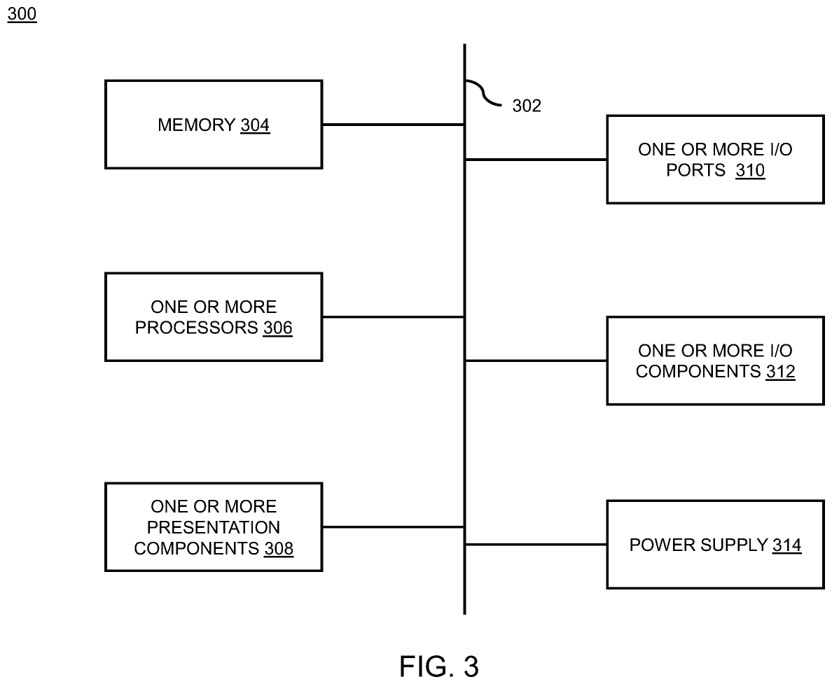

FIG. 3 illustrates a block diagram of the computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 300. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors 306 that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for adaptive ranking of a plurality of video segments in real time, the method comprising:
receiving, at an adaptive ranking system with a processor, a multimedia content, wherein the multimedia content is received from one or more input devices in real-time, wherein the multimedia content is divided to create the plurality of video segments in real-time, wherein the plurality of video segments is created based on one or more parameters;
displaying, at the adaptive ranking system with the processor, the plurality of video segments on one or more social media platforms, wherein the plurality of video segments is displayed on the one or more social media platforms in real time;
ranking, at the adaptive ranking system with the processor, the plurality of video segments displayed on the one or more social media platforms, wherein ranking of the plurality of video segments is based on a performance data of each of the plurality of video segments over the one or more social media platforms, wherein the plurality of video segments is ranked for targeting the plurality of users based on one or more factors, wherein video segments of the plurality of video segments that exceeds a predefined threshold are a first group of video segments;
extracting, at the adaptive ranking system with the processor, one or more attributes associated with the first group of video segments in real-time, wherein the one or more attributes are extracted by performing audio excitement analysis of the first group of video segments; and
clustering, at the adaptive ranking system with the processor, the first group of video segments in real-time, wherein the clustering of the first group of video segments is done based on the one or more attributes and audio excitement analysis to optimize the adaptive ranking system, wherein the first group of video segments are clustered using machine learning algorithms.

2. The computer-implemented method as recited in claim 1, wherein the multimedia content comprising at least one of text, audio, video, animation and graphics interchange format (GIF).

3. The computer-implemented method as recited in claim 1, wherein the one or more parameters comprising at least one of an audio continuity, a video continuity and an intersection of the audio continuity and the video continuity.

4. The computer-implemented method as recited in claim 1, wherein the plurality of video segments is displayed on the one or more social media platforms based on one or more requirements, wherein the one or more requirements comprising at least one of an aspect ratio of the plurality of video segments, an orientation of the plurality of video segments and duration of the plurality of video segments.

5. The computer-implemented method as recited in claim 1, wherein the one or more factors comprising location, community, language, ethnicity, gender and age groups.

6. The computer-implemented method as recited in claim 1, wherein the performance data comprising likes, number of views, watch-hour on the plurality of video segments and number of dislikes, age group of people who like or dislike the plurality of video segments, gender of people that likes or dislikes the plurality of video segments, location at which the plurality of video segments are mostly watched.

7. The computer-implemented method as recited in claim 1, wherein the one or more attributes associated with the first group video segments comprise audio attributes, visual attributes and an intersection of the audio attributes and the visual attributes.

8. The computer-implemented method as recited in claim 1, further comprising sub-clustering, at the adaptive ranking system with the processor, of the first group of video segments, wherein the first group of video segments are sub-clustered to target audience from the plurality of users based on parameters, wherein the parameters comprising location, community, language, ethnicity, gender and age group.

9. The computer-implemented method as recited in claim 1, further comprising targeting, at the adaptive ranking system with the processor, of the first group of video segments, wherein the first group of video segments are targeted on the one or more social media platforms by analyzing device data of a plurality of users.

10. The computer-implemented method as recited in claim 1, further comprising notifying, at the adaptive ranking system with the processor, the first group of video segments, wherein the first group of video segments being notified to each of the plurality of users on the one or more social media platforms.

11. A computer system comprising:
one or more processors; and
a memory coupled to the one or more processors, the memory for storing instructions which, when executed by the one or more processors, cause the one or more processors to perform a method for adaptive ranking of a plurality of video segments in real time, the method comprising:
receiving, at an adaptive ranking system, a multimedia content, wherein the multimedia content is received from one or more input devices in real-time, wherein the multimedia content is divided to create the plurality of video segments in real-time, wherein the plurality of video segments is created based on one or more parameters;
displaying, at the adaptive ranking system, the plurality of video segments on one or more social media platforms, wherein the plurality of video segments is displayed on the one or more social media platforms in real time;
ranking, at the adaptive ranking system, the plurality of video segments displayed on the one or more social media platforms, wherein ranking of the plurality of video segments is based on a performance data of each of the plurality of video segments over the one or more social media platforms, wherein the plurality of video segments is ranked for targeting the plurality of users based on one or more factors, wherein video segments of the plurality of video segments that exceeds a predefined threshold are a first group of video segments;
extracting, at the adaptive ranking system, one or more attributes associated with the first group of video segments in real-time, wherein the one or more attributes are extracted by performing audio excitement analysis of the first group of video segments; and
clustering, at the adaptive ranking system, the first group of video segments in real-time, wherein the clustering of the first group of video segments is done based on the one or more attributes and audio excitement analysis to optimize the adaptive ranking system, wherein the first group of video segments are clustered using machine learning algorithms.

12. The computer system as recited in claim 11, wherein the multimedia content comprising at least one of text, audio, video, animation and graphics interchange format (GIF).

13. The computer system as recited in claim 11, wherein the one or more parameters comprising at least one of an audio continuity, a video continuity and an intersection of the audio continuity and the video continuity.

14. The computer system as recited in claim 11, wherein the plurality of video segments is displayed on the one or more social media platforms based on one or more requirements, wherein the one or more requirements comprising at least one of an aspect ratio of the plurality of video segments, an orientation of the plurality of video segments and duration of the plurality of video segments.

15. The computer system as recited in claim 11, wherein the one or more factors comprising location, community, language, ethnicity, gender and age groups.

16. The computer system as recited in claim 11, wherein the performance data comprising likes, number of views, watch-hour on the plurality of video segments and number of dislikes, age group of people who like or dislike the plurality of video segments, gender of people that likes or dislikes the plurality of video segments, location at which the plurality of video segments are mostly watched.

17. The computer system as recited in claim 11, wherein the one or more attributes associated with the first group video segments comprise audio attributes, visual attributes and an intersection of the audio attributes and the visual attributes.

18. The computer system as recited in claim 11, further comprising sub-clustering, at the adaptive ranking system, of the first group of video segments, wherein the first group of video segments are sub-clustered to target audience from the plurality of users based on parameters, wherein the parameters comprising location, community, language, ethnicity, gender and age group.

19. The computer system as recited in claim 11, further comprising targeting, at the adaptive ranking system, of the first group of video segments, wherein the first group of video segments are targeted on the one or more social media platforms by analyzing device data of a plurality of users.

20. A non-transitory computer-readable storage medium encoding computer executable instructions that, when executed by at least one processor, performs a method for adaptive ranking of a plurality of video segments in real time, the method comprising:
receiving, at a computing device, a multimedia content, wherein the multimedia content is received from one or more input devices in real-time, wherein the multimedia content is divided to create the plurality of video segments in real-time, wherein the plurality of video segments is created based on one or more parameters;
displaying, at the computing device, the plurality of video segments on one or more social media platforms, wherein the plurality of video segments is displayed on the one or more social media platforms in real time;
ranking, at the computing device, the plurality of video segments displayed on the one or more social media platforms, wherein ranking of the plurality of video segments is based on a performance data of each of the plurality of video segments over the one or more social media platforms, wherein the plurality of video segments is ranked for targeting the plurality of users based on one or more factors, wherein video segments of the plurality of video segments that exceeds a predefined threshold are a first group of video segments;
extracting, at the computing device, one or more attributes associated with the first group of video segments in real-time, wherein the one or more attributes are extracted by performing audio excitement analysis of the first group of video segments; and
clustering, at the computing device, the first group of video segments in real-time, wherein the clustering of the first group of video segments is done based on the one or more attributes and audio excitement analysis to optimize the adaptive ranking system, wherein the first group of video segments are clustered using machine learning algorithms.
